(19) United States
(12) Patent Application Publication
(10) Pub. No.: US 2006/0029709 A1
(43) Pub. Date: Feb. 9, 2006

(54) Masticated frozen confection material

(75) Inventor: Arnold P. Zweben, Palm Harbor, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(73) Assignee: Cool Frootz, LLC, Clearwater, FL (US)

(21) Appl. No.: 11/129,610

(22) Filed: May 14, 2005

Related U.S. Application Data
(60) Provisional application No. 60/599,645, filed on Aug. 6, 2004.

(51) Int. Cl. A23G 9/00

(52) U.S. Cl. 426/565

(57) ABSTRACT

A frozen confection made from masticating frozen foodstuffs and such having no air entrapment (overrun); a homogeneous consistency; an increase in total sugar content as compared to the feed material; and a superior mouth feel. This frozen confection possesses an appearance and a mouth feel similar to soft-serve ice-cream without the use of air, dairy, fillers, creaming agents, preservatives, or additives of any sort. Upon processing, the frozen convection made from frozen fruit, vegetables, or foodstuffs shows a gain in natural sugars. Resulting flow characteristics and viscosities are apparently unaffected by the choice of feed materials. This frozen convection is easy to prepare, may be made from countless raw materials, is easy to digest, shows no negative thaw characteristics, and provides high, easily digestible, naturally sweet nutrition with no additives.

### CROSS-REFERENCE TO RELATED APPLICATION

The present application claims the benefit of previously filed co-pending Provisional Patent Application Ser. No. 60/599,645.

### BACKGROUND OF THE INVENTION

People are becoming increasingly preoccupied with the effects of diet on their health and overall wellbeing. For this reason, a growing number of Americans seek to reduce their intake of preservatives and food additives, reduce their consumption of fats and cholesterol, and lower their intake of processed rather than natural sugars. In addition, a growing segment of the population needs to exclude all dairy products from their diet due to allergies. For all of the aforementioned people there is a need for frozen healthful desserts and frozen foods that will allow them to exclude the above named non-desired food ingredients from their diets.

Various devices have been suggested over the years for forming frozen products, such as dessert products like ice cream. An ice cream freezer is disclosed in U.S. Pat. No. 2,749,286 issued to Gerner. Such an apparatus is quite complex as the can itself is rotated during the food making process. U.S. Pat. No. 2,132,364 issued to Thompson, an apparatus is disclosed for forming ice cream wherein air is introduced to create an overrun. Such an apparatus is quite complex and a liquid mix is fed into the air cylinder. In U.S. Pat. No. 2,864,419 to Woock and U.S. Pat. No. 3,976,001 to Trovlager, conventional juicers are disclosed. In Thomas, U.S. Pat. No. 2,513,974, a juice extractor is disclosed in which the ground-up food is merely fed by gravity to the operating cylinder, not pushed as may be necessary with masticated solids. In Carpigiani, U.S. Pat. No. 3,818,716, an ice cream machine is disclosed where the food material is frozen in a cylinder and not thereafter masticated. In Feldpausch, U.S. Pat. No. 5,246,175, an apparatus for making frozen foods including a mastication cylinder, a frozen food material feeder leading into the mastication cylinder, a masticator disposed in the cylinder and an aeration cylinder for introducing air into masticated frozen food fed into the aeration cylinder is disclosed. Feldpausch also discloses the use of a Champion Juicer in order to masticate the frozen food stuffs prior to air entrapment in order to achieve appropriate mouth feel. In addition, Feldpausch U.S. Pat. Nos. 4,948,614 and 5,098,731, disclose frozen nondairy desserts that require significant air entrapment.

None of these apparatus or frozen dessert patents disclose a simple pure masticated frozen foodstuffs with a creamy texture with no air or other ingredients added.

Therefore, there is a need for a masticated frozen dessert or frozen confection product that is sweet without addition of sweeteners (i.e. addition of glucose, dextrose, other natural or artificial sweeteners), has a desirable mouth feel such as soft serve ice cream, has a desirable appearance such as soft serve ice cream, has a desirable odor, and is made without additives or entrained air, that is easy to digest, and that is manufactured in one step.

It is an object therefore of this invention to provide a frozen confection with a creamy texture without the addition of creaming agents or incorporation of air via mechanical means (air overrun), a frozen food product that utilizes as its only ingredient frozen fruits, vegetables, or other foodstuffs.

It is another object of this invention to provide a frozen confection that can be made without the addition of food additives, sweeteners, and preservatives.

It is yet another object to provide a frozen dessert that utilizes as its only ingredient frozen fruits, vegetables, or other foodstuffs and that has no added fat, sugar, or entrained air yet is creamy and sweeter than the fruit prior to processing.

It is yet another object to provide a frozen desert with an average increased weight percent of total sugar content compared to that of the unprocessed frozen fruit.

It is yet another object to provide a frozen desert that has minimal residual content regarding seeds and or large particles thereby enhancing flow characteristics and mouth feel.

This and other objects of the invention will in part be obvious and will in part appear hereinafter.

The invention accordingly comprises the process of creating and manufacturing a composition of new matter possessing the features, properties and the chemical composition and the process involving the steps in relation and order of one or more of such steps with respect each of the others all of which are exemplified in the following detailed disclosure and the scope of the application of which will be indicated in the claims.

For a fuller understanding of the nature and objects of the invention reference should be made to the following detailed description taken in conjunction with the accompanying figures comprising data tables.

### BRIEF DESCRIPTION OF THE FIGURES

The invention will now be described, by way of example only, with reference to the accompanying data tables in which:

FIG. 1 is a table showing relative residual content of material as expressed through a cheese clothe filter illustrating homogeneity of the material.

FIG. 2 is a table showing the relative resistance to flow of the material as compared to materials manufactured by other commercially available machines;

FIG. 3 is a table showing before and after total sugar content of feed and resultant materials respectively as processed as compared to a commercial juicer.

FIG. 4 is chart showing the relative percent sugar comparing the object of this invention to the proceed food stuffs derived from a commercial juicer.

FIG. 5 is an illustration showing the method of determination for the percent overrun in the processed fruit material.

FIG. 6. shows the relative percent overrun and average bulk density of the material as proven in testing

FIG. 7. shows total proximate and caloric data for the apparatus as compared to a Juicer, juicer A.

FIG. 8. is a chart showing the change in reducing sugars using the Copper Reducing sugars test

### SUMMARY OF THE INVENTION

A frozen confection or dessert product made from frozen fruits, vegetables, spices, or other foodstuffs (“instantly quick frozen” (IQF) or other) and processed such that the new frozen confection has an appearance and creamy mouth feel similar to soft serve ice-cream with no added materials to aid mouth feel and no air entrapment is disclosed.

The material may be made from frozen fruits, vegetables, spices, or other foodstuffs and the method of freezing has no impact upon the final mouth feel of the product. Pieces of the frozen fruits, vegetables, spices, or other foodstuffs are fed into a specialized masticating apparatus previously disclosed by this inventor and processed without the addition of creaming agents, binders, or flow additives such as milk or dairy products, certain thickeners such as alginates or cellulose, added soluble/non-soluble fibers or extracts thereof, or air. The resultant material frozen confection is a creamy confection with a relatively low resistance to flow and an average bulk density greater than twice that of the actual fruit before processing. The frozen fruit, vegetables, spices, or other foodstuffs are transmogrified into this new material via one step as performed in the disclosed apparatus (TMU).

The frozen fruit experiences such high shear and pressure, that a change in sugar content is experienced such that a consistent change in the composition of sugars is shown. Typical increases of greater than 20% for sucrose, glucose, and fructose are shown between the composition of the raw bananas and the composition of bananas that are processed in the TMU. The change in sugar composition appears to be unique to the transmogrified material of this invention. Frozen bananas from the same batch were processed using a commercially available juicer and the results showed a decrease of total sugars in the range of 32% (or a negative 32% change in total sugar content).

When using frozen fruits, this novel processing results in a new non-dairy frozen dessert comprised of quick frozen fruit composite which has been transmogrified to achieve a desired creamy texture. Fruit, vegetables, or other frozen foodstuffs may be used alone or in combination with other flavoring agents such as spices, vanilla extract, oils such as mint and powders or liquors such as cocoa and carob.

### DESCRIPTION OF THE PREFERRED EMBODIMENT

In U.S. Ser. No. 10/852,542, filed on May 24, 2004, the inventor of this application disclosed a novel frozen food masticating machine. The contents of that disclosure are incorporated herein. The present invention relates to the method of processing using the previously disclosed or similar machines and the resultant frozen confection comprised of frozen fruits, vegetables, spices, or other foodstuffs which has properties such as taste, appearance, and mouth feel similar to soft serve ice cream.

The invention of this disclosure differs from all of the frozen confection products which start with a liquid comprised of a mixture of some or all of the following; dairy products, water, fruit concentrates, sugar, emulsifiers, thickeners, fragrances, stabilizers, colors, and fats derived from vegetable, and/or animal sources. Typically the liquid is cooled and frozen while being whipped. The whipping action is what gives the products its overrun which is the entrainment of air therein. The percent of overrun is an expression of the amount of air that is frozen in the resultant dessert. This entrainment of air is what usually gives the whipped frozen foodstuffs its creamy texture. The frozen confection of this disclosure has the creamy texture desired without any addition of emulsifiers, thickeners, or binding agents and the like and without any overrun.

Many frozen confections have a creamy texture with desirable mouth feet and these products are manufactured using techniques that employ the use of thickeners such as cellulose, dairy products, soluble or insoluble fiber. Further, it is considered necessary by the prior art to employ an overrun, or to add air to the material, in a fashion by which to impart a foamy or whipped material. This invention creates a product of equal if not superior quality regarding mouth feel and creamy quality while using only 100% pure frozen fruits, vegetables, spices, or other foodstuffs with no added ingredients. The material disclosed in this application is of a homogeneous nature in that the feed materials are ground so fine that virtually no traces of small seeds or fiber are visible or felt in the mouth. All combinations of fruit or vegetables are completely mixed to create new flavors and taste stimulation. This is done while the foodstuffs are still frozen so there is no need for an additional refrigerating means as part of the processing. Dairy products are not needed for body or flavor. The finished product holds its shape long after thawing occurs. Upon thawing, there is no observable sweating or condensation from the material, indicative of the complete homogeneity of the blend and separation of complex multi-cellular structures such as starch or fiber. The separation of various components of the frozen fruits, vegetables, spices, or other foodstuffs also would explain the binding of any water keeping it from releasing in the form of sweating or condensation.

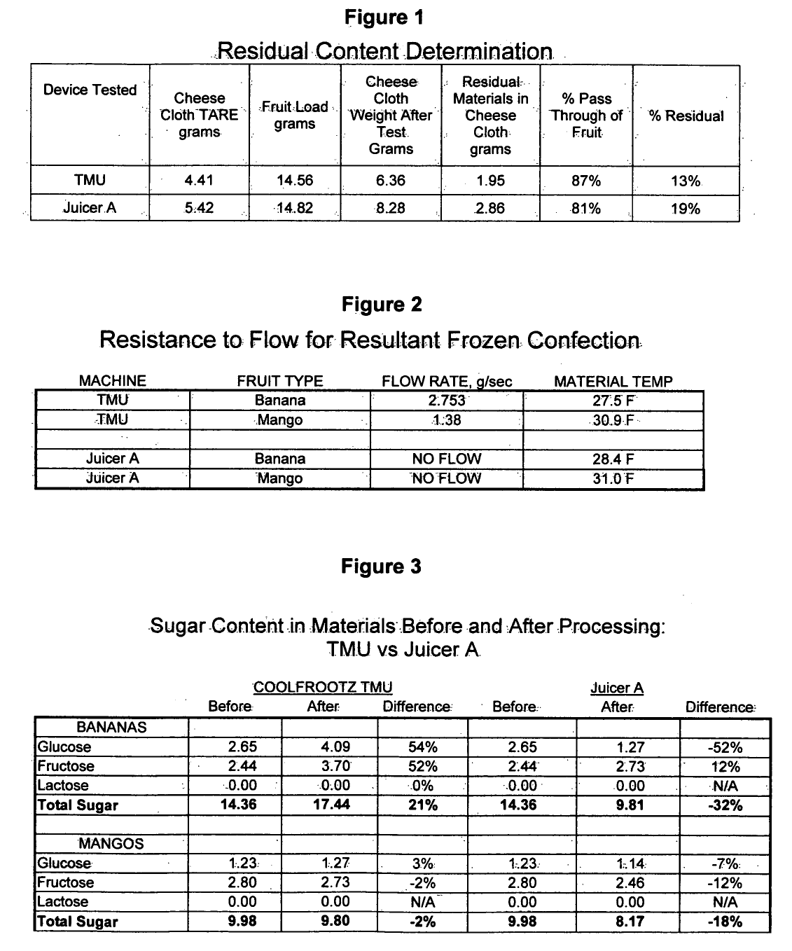

This frozen confection has zero overrun or entrapped air as processed on the disclosed apparatus and therefore is manufactured in one simple step. This single action facilitates a smooth and creamy mouth feel without the use of air to whip the material. The lack of air also acts to prevent excess oxygen that degrades or oxidizes the frozen confection. Referring to Table 5, this frozen confection was tested in order to determine percent overrun using testing measures from the paint and coatings industry. The data indicates a zero percent overrun in the apparatus product and shows the densification of the material upon processing. However, the frozen confection of this invention has a substantially creamy and rich mouth feel more so than the resultant material from the other machines. This is illustrated by flow (FIG. 2) and residual content data (FIG. 1) disclosed in the other tables.

Tests to determine the percent of air entrapment were also performed. The purpose of the tests was to determine percent overrun or percent entrapped air in the frozen material product. The following is a description of the procedure and results.

In order to test for entrapped air when dealing with viscous materials, the use of a diluent is employed in order to thin the viscous material to thereby release any entrapped air. That is, by adding a diluent to an air overrun material, the final volume would be less the sum of the two volumes. The procedure for this test is further shown in FIG. 5. Therefore, it can be shown:
Overrun % (% volume)=(Vᵢ+V_{d}/V)−1
1. Seven frozen fruit products, some of which were purchased “instantly quick frozen” or IQF, and blends thereof, were selected for testing on the apparatus.
2. A known weight of frozen fruit or fruit blend was fed into the apparatus, processed into the frozen material, and collected in a volumetric container (graduated cylinder or graduated beaker).
3. The frozen material was weighed and then gently pushed down to remove any large air pockets caused by the viscous material folding path into the container.
4. A known volume and weight of deionized water diluent was then added to the frozen material.
5. The resultant volume was then observed.

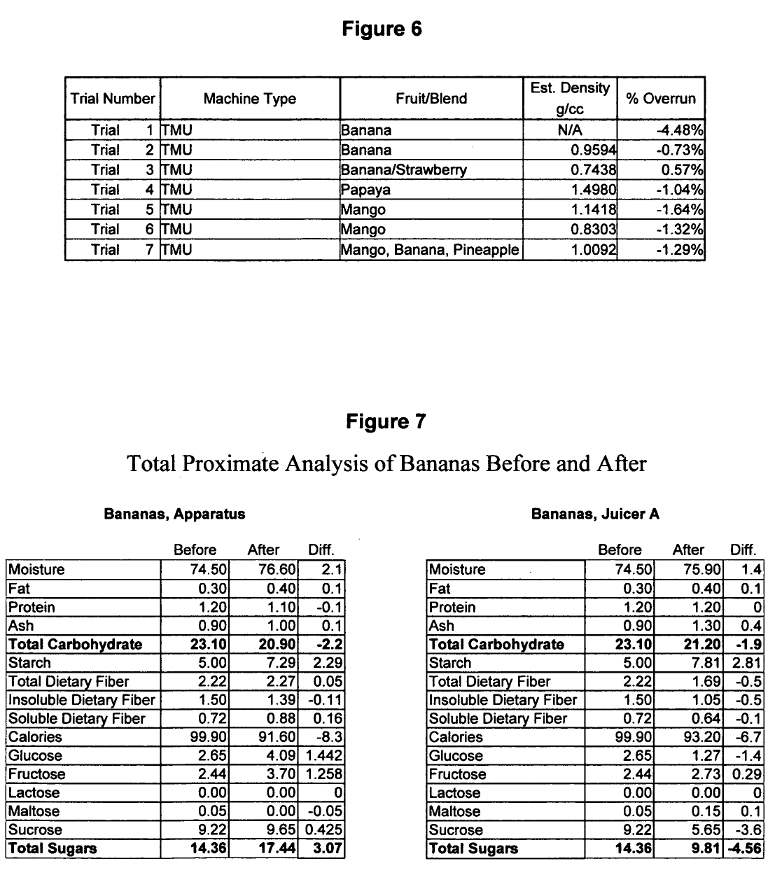

The results of this test is shown in the chart disclosed in FIG. 6. Density data was interpreted as follows: Density (g/cc)=weight of material/volume in cc.

Because of the need to not generate too much heat during the mastication process the number of cuts per revolution is key to the successful operation of the apparatus and processing of the feed materials. The frozen food product is cut up to 8 more times per revolution than conventional crushing and juicing machines when operating. The material is thus finely blended or masticated in order to transmogrify the feed into an extremely homogeneous frozen confection. Table 1 shows relative residual content as obtained from this frozen confection as related to a juicer. The data is presented in weight percentage. Feed material was processed by the apparatus and then forced through cheese cloth with constant force. For instance, the frozen confection as processed on the apparatus showed an average of less than 13% residual content while a commercially available juicer showed almost 20% residual content retained on the cheese cloth. This translates to a greater than 35% difference between materials processed on the apparatus verses other machines. The reduction in larger strands of fiber or starch as well as the mechanical degradation of seeds or pulp is obvious to the final mouth feel of the product.

The frozen fruits, vegetables, or foodstuffs are masticated and blended thoroughly and with homogeneity to produce a transmogrified material with extreme creaminess and desirable mouth feel. Viscosity experiments were performed on the frozen confection using traditional mechanisms, however it was determined that traditional Brookfield Viscometer equipment was not appropriate for this determination due to the spindle forming air pockets within the frozen material. In order to illustrate the novel and unambiguous differences between this product and prior art a resistance to flow Wet was devised and the results are illustrated in Table 2. Results for viscosity are included in Table 2 and illustrate the flow rates for the frozen fruit, vegetable, or foodstuffs used in the process. Materials processed in Juicer A exhibited 0 flow while the processed frozen confection of this disclosure were able to flow through an orifice at rather expedient flow rates. This further quantifies the creamy texture of the frozen confection.

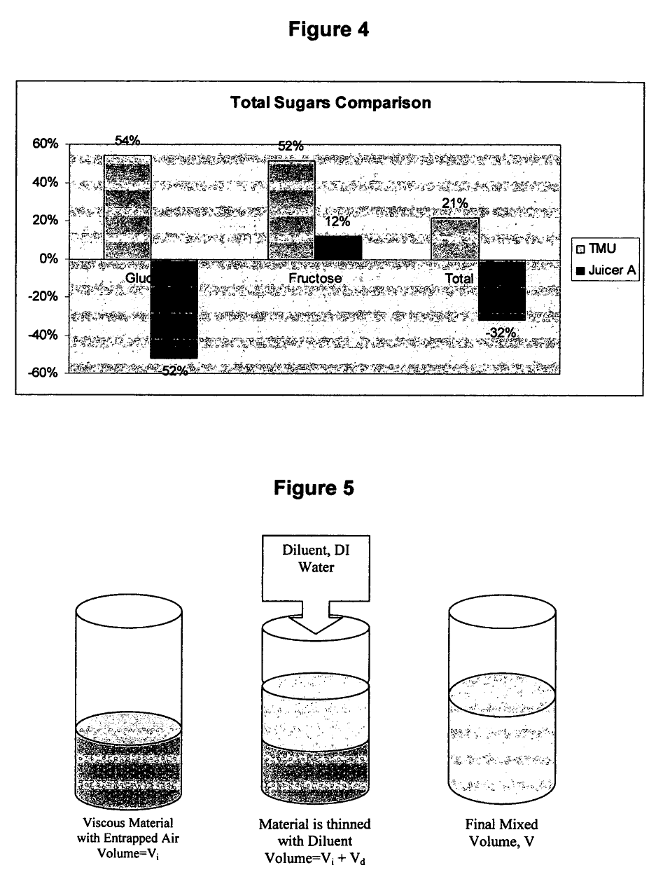

As disclosed in Table 3 novel changes in the content and type of sugar present in the frozen confection are shown before and after processing. This data supports taster testimonies stating that this frozen confection tastes “sweeter” than the frozen material prior to processing. Per the data, bananas processed in the apparatus to make the frozen confection showed a net gain in total sugar content of greater than 21%, with the glucose levels rising 54%. Juicer A showed a net decrease of more than 32% (overall change of −32%). FIG. 4 is a graphic representation of notable differences in the sugar composition of the two compositions of frozen fruit product.

The increase in total sugar content also indicates a possible decrease in larger carbohydrate molecules such as homopolymer of glucose and heteropolymers of glucose and fructose. Data from Table 7 shows proximate values indicating a decrease in total carbohydrate content when processing bananas in the apparatus; 23.10% by weight to 20.90% by weight. Experimentation using iodine as a starch indicator showed a consistent decrease in starch content for the frozen materials processed in the apparatus. These test results indicate that a substantial change is occurring within the material during the process. As disclosed in U.S. Ser. No. 10/852,542, the apparatus processes the fruit within a chamber with very small tolerance around the masticating element. It is proposed that high shear and pressure results in the actual breakdown of longer chain molecules perhaps resulting the formation of tri or di-saccharide molecules. This would explain the increase in total sugar and the reduction in total carbohydrate. This result was somewhat consistent in the commercially available juicer, however the increased sugar content was not observed. The creamy texture of the of this Frozen Confection is unique because it is the result of the sheering nature of the masticating element and not from added emulsifiers or overrun as shown in the test described below. Fruit, vegetables, or other frozen foodstuffs may be used alone or in combination with other flavoring agents such as vanilla extract, oils such as mint and powders or liquors such as cocoa and carob. This unique process results in a naturally sweetened creamy material with increased sugar content and a mouth feel that exceeds the quality of materials that are whipped or contain air overrun. This material also possesses excellent thaw-proof characteristics in that the material win not melt quickly

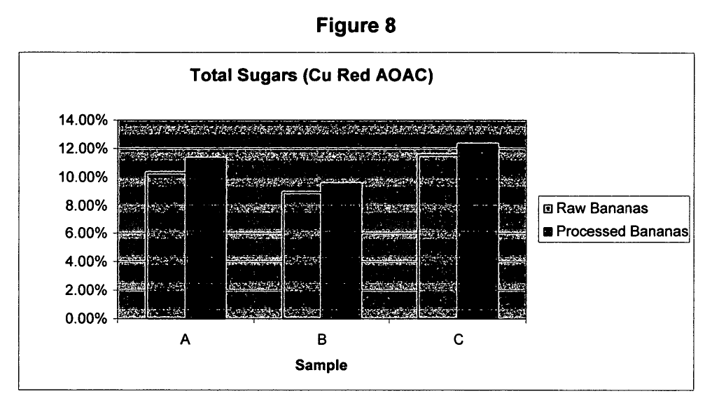

FIG. 8 is a graphic representation of the data obtained from a reducing sugars tests performed by an independent testing service. Three sets of samples were obtained from a single batch of bananas that were gently mashed together to achieve some base line level of homogeneity. The three sets (A, B, C) were then frozen. One sample of each set was then tested as is while the other sample of each set was processed through the apparatus and subsequently tested. The data shows consistent increases in the weight percentage of compositional sugars in the fruit processed in the apparatus. This before and after test further supports the affect of increasing total sugar levels in the final product.

It can be seen that what is disclosed is a superior frozen confection that is manufactured via a novel process using the high shear and pressure of the previously disclosed apparatus. The frozen confection has a creamy texture without any added air, dairy products, or other texture enhancing materials. This frozen confection is highly homogeneous and shows an actual increase in total sugar content upon manufacture. The frozen confection flows readily and has a lower viscosity than other materials made from the same frozen fruit, vegetables, or foodstuffs. There are virtually no restrictions to raw materials regardless of water, starch, or sugar content that can be processed into the frozen confection. The process of manufacture is simple and straight forward. Although a specific embodiment of the invention has been disclosed, variations thereof may occur to an artisan and the scope of the invention is only to be limited by the scope of the appended claims.

What is claimed is:

1. A non-dairy frozen confection made from frozen fruits or vegetables consisting essentially of:
a masticated foodstuff composite of said frozen fruits or vegetables;
said masticated foodstuff composite having no entrapped air;
said masticated foodstuff composite having increased bulk density over said frozen fruits or vegetables;
said masticated foodstuff composite having increased total sugar content over said frozen fruits or vegetables; and,
said masticated foodstuff composite having a homogeneous consistency.

2. The non-dairy frozen confection of claim 1, wherein said confection consists of any frozen fruit material.

3. The nondairy frozen confection of claim 1, wherein said confection consists of a blend of frozen fruit and frozen vegetables

4. The nondairy frozen confection of claim 1, wherein said confection consists of frozen vegetables.

5. The nondairy frozen confection of claim 1 wherein the bulk density of the resultant confection is at least 50% more than the bulk density of the raw stating materials.

6. The nondairy frozen confection of claim 1 wherein there is an increase in total sugar content of greater than 3%.

7. The nondairy frozen confection of claim 1 wherein there is an increase of glucose between 2 and 24% by weight.

8. The nondairy frozen confection of claim 1 wherein there is an increase of fructose between 2 and 24% by weight.

9. The nondairy frozen confection of claim 1 wherein there is an increase of sucrose between 2 and 24% by weight.

10. A nondairy frozen confection consisting of 100% frozen foodstuffs with an average overrun of entrapped air of −4.50 to 0.5% by volume.

11. A nondairy frozen confection wherein there is a bulk density of between 0.7 to 1.5 grams per cubic centimeter.

12. A method of making a non-dairy frozen confection made from frozen fruits or vegetables comprising:
freezing said frozen fruits or vegetables; and,
masticating said frozen fruits or vegetables using high sheer and pressure resulting in a foodstuff composite which has no entrapped air and a homogeneous consistency.

13. A method of making a non-dairy frozen confection made from frozen fruits or vegetables comprising:
freezing said frozen fruits or vegetables; and,
masticating said frozen flits or vegetables using high sheer and pressure resulting in a foodstuff composite having increased bulk density over said frozen fruits or vegetables and a homogeneous consistency.

14. A method of making a non-dairy frozen confection made from frozen fruits or vegetables comprising:
freezing said frozen fruits or vegetables; and,
masticating, said frozen fruits or vegetables using, high sheer and pressure resulting in a foodstuff composite having increased total sugar content over said frozen fruits or vegetables and a homogeneous consistency.

15. A method of making the non-dairy frozen confection of claim 12, wherein said confection consists of any frozen fruit material.

16. A method of making the non-dairy frozen confection of claim 12, wherein said confection consists of a blend of frozen fruit and frozen vegetables.

17. A method of making the non-dairy frozen confection of claim 12, wherein said confection consists of frozen vegetables.

18. A method of making the non-dairy frozen confection of claim 13 wherein the bulk density of the resultant confection is at least 50% more than the bulk density of the raw stating materials.

19. A method of making the non-dairy frozen confection of claim 14 wherein the there is an increase in total sugar content of greater than 3%.

20. A method of making the non-dairy frozen confection of claim 14 wherein there is an increase of glucose between 2 and 24% by weight.

21. A method of making the non-dairy frozen confection of claim 14 wherein there is an increase of fructose between 2 and 24% by weight.

22. A method of making the non-dairy frozen confection of claim 14 wherein there is an increase of sucrose between 2 and 24% by weight.
